(19) United States
(12) Patent Application Publication
(10) Pub. No.: US 2009/0327074 A1
(43) Pub. Date: Dec. 31, 2009

(54) METHOD AND APPARATUS FOR ADVERTISING SPECTRUM IN A COMMUNICATION SYSTEM

(75) Inventors: Edgar H. Callaway, JR., Boca Raton, FL (US); David B. Taubenheim, Plantation, FL (US)

Correspondence Address: MOTOROLA, INC, 1303 EAST ALGONQUIN ROAD, IL01/3RD, SCHAUMBURG, IL, 60196, US

(73) Assignee: MOTOROLA, INC, Schaumburg, IL (US)

(21) Appl. No.: 12/165,614

(22) Filed: Jun. 30, 2008

(51) Int. Cl. G06Q 30/00; G06Q 10/00

(52) U.S. Cl. 705/14.49; 705/80

(57) ABSTRACT

The application discloses a method and apparatus for advertising a spectrum in a wireless communication system. The method includes obtaining an address of a broker device authorized to negotiate access to the spectrum, and sending an inquiry message to the broker device for negotiating access to at least a portion of the spectrum. The method then includes receiving an agreement message including an advertisement text from the broker device when the first user device agrees to negotiating terms associated with the broker device. The advertisement text includes information related to the portion of the spectrum and the broker device. The method further includes transmitting a packet including the advertisement text to at least one other user device such that the at least one other user device communicates with the broker device for allocation of the portion of the spectrum.

### FIELD OF THE DISCLOSURE

The present disclosure relates generally to a wireless communication system and more particularly to a method and apparatus for advertising spectrum in a wireless communication system.

### BACKGROUND

In a wireless communication system, typically frequency spectrum is divided into a plurality of frequency bands and each frequency band is licensed to a user known as a license holder. The license holder may hold a license to the complete spectrum or a portion of the spectrum and is considered as an authorized user of that spectrum. The license holder may also sub-license or share the spectrum with other users in the wireless communication system. In general, the license holder may demand or negotiate a fee from other users seeking to access the spectrum.

In the existing technology, the license holder or broker may himself advertise the presence of available spectrum. However, it is frequently difficult for potential spectrum users to find these advertisements, and it would be commercially desirable to maximize the readership of these advertisements.

Also, in some wireless communication systems, there may be a number of brokers or license holders that are ready to share their portion of the spectrum with other users but, the other users are unaware of the brokers or the existing license holders. Thus, today's spectrum is not efficiently commercialized or utilized by users seeking to establish communication.

Accordingly, there exists a need for efficiently commercializing and utilizing the spectrum in a wireless communication system.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic of a wireless communication system in accordance with some embodiments.

FIG. 2 is a block diagram of a user device in accordance with some embodiments.

FIG. 3 is a flowchart of a method for advertising a spectrum in a wireless communication system in accordance with some embodiments.

FIG. 4 is a detailed signal flow diagram of a method for advertising a spectrum in a wireless communication system in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present disclosure is directed towards a method for advertising spectrum in a wireless communication system. The method includes obtaining an address of a broker device authorized to negotiate access to the spectrum, and sending an inquiry message to the broker device for negotiating access to at least a portion of the spectrum. The method then includes receiving an agreement message including an advertisement text from the broker device when a first user device agrees to negotiating terms associated with the broker device. The advertisement text includes information related to at least one of the portion of the spectrum and the broker device. The method further includes transmitting a packet including the advertisement text to at least one other user device such that the at least one other user device communicates with the broker device for allocation of the portion of the spectrum.

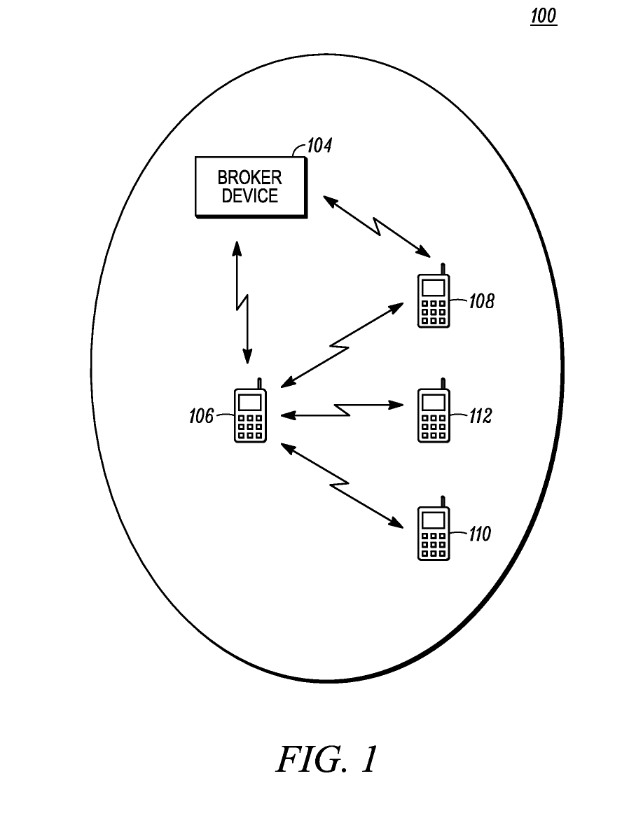

FIG. 1 illustrates a schematic of a wireless communication system 100 in accordance with some embodiments. The wireless communication system 100 includes a plurality of user devices 106, 108, 110, 112, and a broker device 104 located at different positions in the wireless communication system 100. It should to be noted that there can be any number of user devices and broker devices in the wireless communication system 100, and not limited to the devices 104-110 shown in FIG. 1. The wireless communication system 100 also includes spectrum that acts as a communication media to provide communication to the devices 104-112. In general, the spectrum is a band of frequencies that is divided into a plurality of sub-band of frequencies known as frequency channels or frequency bands. For the purposes of this application, a group of frequency channels shall also be referred to as spectrum.

In accordance with the embodiment, the user device 106 may use a frequency channel to communicate with other user devices 108-112 or broker device 104 in the communication system 100. In general, the user device 106 may use a portion of the spectrum for communication. However, the user device 106 can access the spectrum only if the user device 106 is authorized or licensed to the spectrum. The user device 106 obtains such access by negotiating with an entity (not shown) authorized to use the spectrum. The entity may be associated with a license holder authorized to use or share the spectrum with the user devices 106-112 in the communication system 100. The entity associated with the license holder may be any device that resides within the wireless communication system 100 or may be outside the wireless communication system 100. In another embodiment, the user device 106 may negotiate with the broker device 104 which is associated with an authorized agent of the entity. The broker device 104 may also reside within the wireless communication system 100 or outside the wireless communication system.

In accordance with the embodiment, the broker device 104 may be any user device, infrastructure device, access point, base station, cognitive radio, or any similar device that can negotiate with at least one other user device in the communication system 100.

In accordance with the embodiment, the user device 106-110 in the communication system 100 may be a cognitive radio, a wireless device, a mobile station, a user equipment, or any similar device that can transmit and receive signals. Also, the devices 104-112 are configured to operate according to any of a number of different communication technologies including, but not limited to, 2G, 3G and 4G wireless communication technologies. These include Global System for Mobile Communication (GSM), Code Division for Multiple Access (CDMA), Universal Mobile Telecommunication System (UMTS), Wideband Code Division for Multiple Access (W-CDMA), Orthogonal Frequency Division Multiplexing (OFDM), Worldwide Interoperability for Microwave Access (WiMax), Long-Term Evolution (LTE) and other communication technologies.

Operationally, the user device 106 receives an address of a broker device 104 that is authorized to negotiate access to the spectrum. For example, the user device 106 may receive the address from another user device 108 in the communication system 100. The address may be any kind of information that is used to contact the broker device 104 or a broker associated with the broker device 104. In one embodiment, the address may include a modulation format or frequency on which the user device 106 may communicate with the broker device 104. The user device 106 then sends an inquiry message to the broker device 104 for negotiating access to at least a portion of the spectrum. In response to sending the inquiry message, the user device 106 negotiates with the broker device 104 for advertising availability of the portion of the spectrum to other user devices 108-112. Upon negotiating with the broker device 104, the user device 106 receives an agreement message including an advertisement text from the broker device 104. The advertisement text includes information related to the portion of the spectrum and the broker device 104. The user device 106 finally inserts the advertisement text in a packet and transmits the packet to at least one other user device 112 such that the at least one user device 112 communicates with the broker device for allocation of the portion of the spectrum.

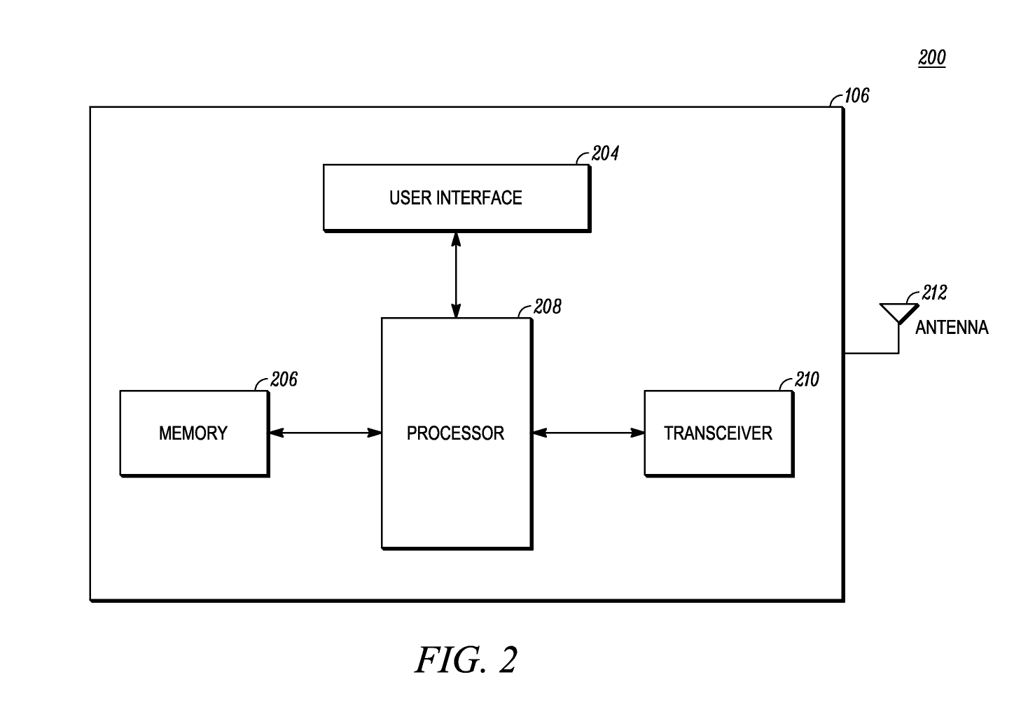

FIG. 2 is a block diagram illustrating exemplary internal components of a user device 200 in accordance with some embodiments of the invention. It should be noted that the user device 200 may represent any user device 106-112 in FIG. 1. For understanding functionality of the internal components, the user device 200 is referred to as the user device 106 of FIG. 1. The exemplary components include a user interface 204, a memory 206, a processor 208, a transceiver 210, and an antenna 212. Although not shown, the user interface 204 may include an input device and an output device. In one embodiment, the output device may be used to display the advertisement text to a user associated with the user device 200.

In accordance with an embodiment, the memory 206 is coupled to the processor 208 of the user device 200 to store the advertisement text received from the user devices 108-112 and the broker device 104. The advertisement text includes information related to the portion of the spectrum and the broker device 104. In one embodiment, the advertisement text includes information related to at least one of a) availability of the portion of the spectrum, b) terms of service, c) cost of service, d) special promotion, and e) contact information of a broker associated with the broker device. The availability of the portion of the spectrum indicates the number of frequency channels available in the spectrum. The terms of service indicates terms to be followed by the user device 200 to obtain access to the spectrum. The special promotion indicates offers or incentives available to gain access to the spectrum, for example, 50% discount on the cost for a particular portion of the spectrum, if the user device 200 agrees to advertise the availability of the spectrum to other user devices 108-112. Contact information of the broker may indicate any kind of information such as an address, e.g., an IP address, of the broker device 104 associated with the broker, contact number of the broker, address of the broker, and physical location of the broker device 104. In one embodiment, the advertisement text indicates availability of in-band and out-of-band spectrum. In-band spectrum may be a band of frequencies that are available within the spectrum, and the out-of-band spectrum may be a band of frequencies that are available outside the spectrum.

In accordance with the embodiment, the memory 206 may maintain a database of a plurality of advertisement texts and may associate each advertisement text to an index or advertisement format. The memory 206 may map the advertisement text to a corresponding advertisement format or index received from the broker device 104.

In accordance with an embodiment, the memory 206 is also adapted to store an address or addresses of the broker device 104. The address may be any kind of information used to contact the broker device 104 or the broker associated with the broker device 104. In one embodiment, the address may include a modulation format or frequency information on which the user device 106 may communicate with the broker device 104.

In accordance with the embodiment, the transceiver 210 coupled to the processor 208 enables the user device 200 to receive the advertisement text transmitted by other user devices 108-112 or the broker device 104. The transceiver 210 is adapted to tune to any range of frequencies so as to receive the advertisement text communicated by other devices 104, 108-112. In general, the transceiver 210 is kept powered ON for scanning different frequency channels so as to read the advertisement text transmitted in any frequency channel. Due to the mobile nature of the user device 200, the transceiver 210 may perform wireless communication. An exemplary function of the user device 200 as represented by the block diagram, upon reception of wireless signals via the antenna 212, the transceiver 210 demodulates the communication signals to recover incoming information, such as voice and/or data, transmitted by the wireless signals.

Further, moving back to the internal components of the user device 200, the processor 208 is coupled between the memory 206 and the transceiver 210. The processor 208 receives an address of the broker device 104 from other user device, such as user device 108, and stores such address in the memory 206 of the user device 200. The processor 208 then uses the stored address to contact and negotiate with the broker device 104 for advertising availability of at least the portion of the spectrum to at least one user device 112-110. The processor 208 negotiates on negotiating terms associated with the broker device 104 when a user associated with the user device 200 disagrees with at least one of the negotiating terms offered by the broker device 104. The negotiating terms includes at least one of a) updating advertisement text at regular intervals, b) length of the advertisement, c) frequency of transmission of the advertisement, d) cost of spectrum access, e) bandwidth of the portion of spectrum, f) length of time the portion of the spectrum is to be used, and g) a physical location. The processor 208 may negotiate on the negotiating terms received from the broker device. The processor 208 may negotiate by interacting and suggesting user terms, agreed by the user, to the broker device 104. The processor 208 continues to negotiate with the broker device until the user associated with the user device 200 agrees to each of the negotiating terms offered by the broker device.

In an exemplary embodiment, negotiation may take place without involving the user associated with the user device 200 and the broker device 104. The user device 200 may store a predetermined policy, for example, a cognitive radio policy, that may have a set of predefined instructions or conditions to agree or disagree with the negotiating terms offered by the broker device 104, either separately or in combination. For example, a condition in the policy may be the user device 200 expecting a fastest or a lowest cost communication. The negotiation may be successful only when the policy agrees to at least a predefined number of the negotiating terms associated with the broker device 104. In another embodiment, the negotiation may be successful if the broker device 104 modifies the negotiating terms as per the policy of the user device 200.

In another embodiment, user terms associated with the user device 200 may be transmitted to the broker device 104, and the broker device 104 may map with the negotiating terms associated with the broker device 104. In this case, the broker device 104 may have the privilege to analyze the user terms offered by different user devices and select a particular user device 200 for negotiation. For example, the broker device 104 may select the user device 200 which charges a low fee for advertising the advertisement text in the communication system 100.

Further, if the user associated with the user device 200 agrees to negotiating terms of the broker device 104, the processor 208 receives an agreement message that includes the advertisement text. The advertisement text includes information related to the spectrum and the contact information of the broker device 104. In one embodiment, the agreement message may include an advertisement format or index referring to a predetermined advertisement text stored in the memory 206 of the user device 200. In another embodiment, the agreement message may include an updated advertisement text for updating the corresponding advertisement text pre-stored in the memory 206 of the user device 200.

Upon receiving the advertisement text, the processor 208 inserts the advertisement text in a packet and transmits the packet to the user devices 108-112 so that the user devices 108-112 will be aware of the availability of the spectrum. Also, the user devices 108-112 may negotiate with the broker device 104 to obtain access to the spectrum.

In one embodiment, the processor 208 may insert the advertisement text in an unencrypted field of the packet so that the other user devices 108-112 acting as eavesdropping devices may easily read the advertisement text in the packet. In an alternative embodiment, the processor 208 inserts the advertisement text in a first field of the packet such that the user devices switches from an active mode to a sleep mode after detecting at least a portion of the advertisement text in the first field of the packet. In another embodiment, the processor 208 may transmit the packet including the advertisement text at a predefined position in each sequence of packets so that the other user devices 108-112 may predict when the advertisement text will be sent and also, the user devices 108-112 may decide when to listen based on at least in part on this prediction.

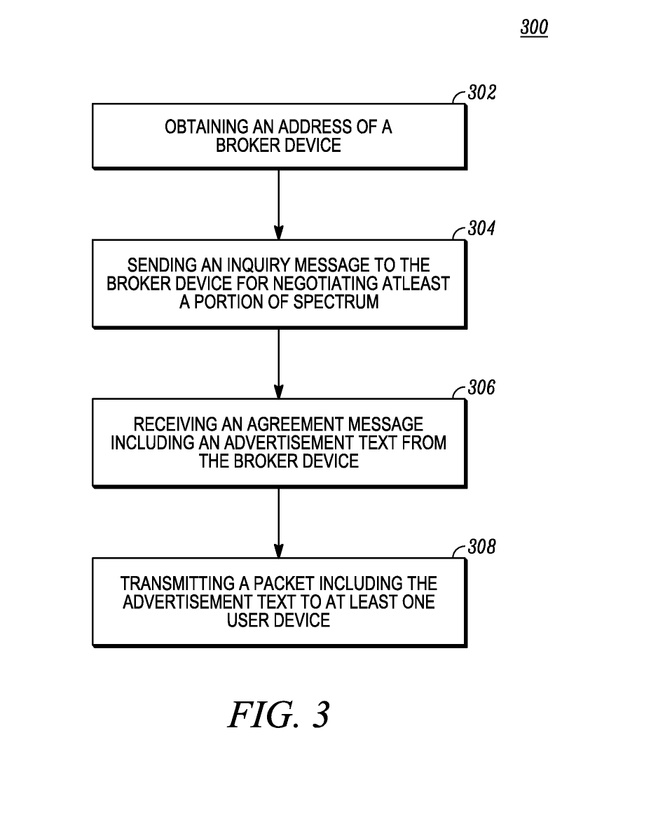

FIG. 3 is a flowchart of a method for advertising spectrum in a communication system 100. Please note that the method 300 is described from the perspective of the user device 106 shown in FIG. 1. Referring to FIG. 3, the method begins with a step of obtaining 302 an address of a broker device 104 which is authorized to negotiate access to the spectrum. The address may be obtained from other user device 108 or from an internal memory of the user device 106. The address may be any kind of information that is used to communicate with the broker device 104.

Upon obtaining 302 the address of the broker device 104, the method continues with a step of sending 304 an inquiry message to the broker device 104 for negotiating access to at least a portion of the spectrum. The inquiry message is sent to confirm availability of at least the portion of the spectrum. The inquiry message also informs the broker device 104 that the user device 106 is available for negotiating access to the spectrum. The user device 106 then negotiates with the broker device 104 and if the user device 106 agrees to the negotiating terms associated with the broker device 104, the method continues with a step of receiving an agreement message including an advertisement text from the broker device 104. The advertisement text includes information related to the portion of the spectrum and the broker device 104. In one embodiment, the advertisement text may be received separately or individually as an advertisement message, after receiving the agreement message from the broker device 104.

The method 300 then continues with a step of transmitting a packet including the advertisement text to at least one other user device 110-112, such that the at least one other user device 110-112 communicates with the broker device 104 for allocation of the portion of the spectrum. In one embodiment, the advertisement text includes information related to at least one of a) availability of the portion of the spectrum, b) terms of service, c) cost of service, d) special promotion, and e) contact information of a broker associated with the broker device 104. In another embodiment, the information may be compressed in a form of indices to a predetermined look-up table so as to reduce transmission time in the communication system 100.

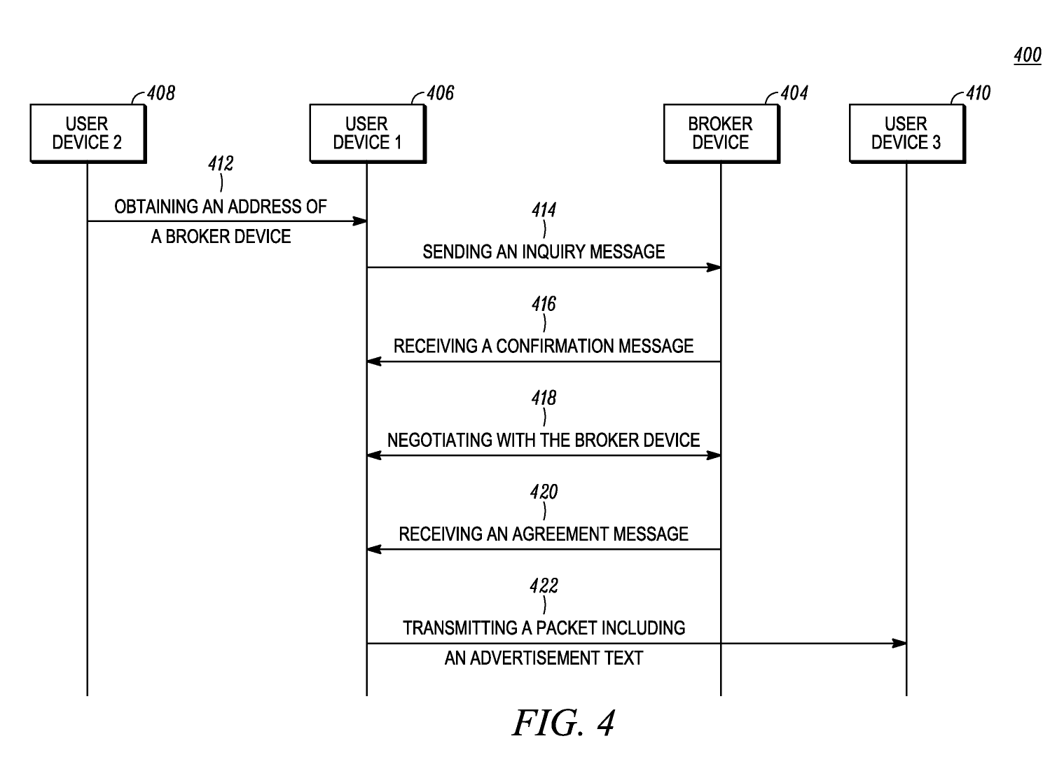

FIG. 4 is a detailed signal flow diagram of the method 400 for advertising spectrum in the communication system 100. FIG. 4 elaborates the steps 304-308 of FIG. 3. Referring to FIG. 4, the method 400 starts with a step of user device-1 406 obtaining 412 an address of a broker device 404 from the user device-2 408. In one embodiment, the address may be obtained from an internal memory of the user device-1 406. Upon receiving the address, the method 400 continues with a step of user device-1 406 sending 414 an inquiry message to the broker device 404 to confirm availability of the portion of the spectrum.

The method 400 then continues with a step of user device-1 406 receiving 416 a confirmation message indicating the availability of the portion of the spectrum. The confirmation message includes information for negotiating with the broker device 404. The method then continues with a step of negotiation 418 between the user device-1 406 and the broker device 404. The negotiation is mainly on the negotiating terms associated with the broker device 404. The negotiating terms includes at least one of a) updating advertisement text at regular intervals, b) length of the advertisement, c) frequency of transmission of the advertisement, d) cost of spectrum access, e) bandwidth of the portion of spectrum, f) length of time the portion of the spectrum is to be used, and g) a physical location. Physical location may be included because wireless signals generally weaken with distance from their source, and those of ordinary skill in the art recognize that a frequency may be used simultaneously by multiple transmitters without harmful interference if sufficient distance exists between them (so-called “spatial re-use”). In addition, there may be regulatory limitations on transmissions on specific frequencies in specific physical locations.

Upon negotiating, the method 400 continues with a step of user device 1 receiving an agreement message 420 including an advertisement text from the broker device 404 when the first user device agrees to negotiating terms associated with the broker device. The advertisement text includes information related to the portion of the spectrum and the broker device 404. The method then continues with a step of user device-1 transmitting a packet 422 including the advertisement text to at least one other user device-3 410 such that the at least one other user device-3 communicates with the broker device 404 for allocation of the portion of the spectrum.

Thus, the spectrum is efficiently commercialized and also, the spectrum is efficiently and dynamically utilized by the users for establishing communication in the wireless communication system 100.

Brokers and license holders may allocate portions of spectrum to a plurality of spectrum users. Because the method enables users, as well as brokers and license holders, to advertise on behalf of the brokers and license holders, the method enables a wider distribution of the advertisements. There is, therefore, a more efficient commercialization of spectrum and a more liquid and efficient spectrum allocation market.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method by a first user device for advertising spectrum in a communication system, the method comprising:
obtaining an address of a broker device authorized to negotiate access to the spectrum;
sending an inquiry message to the broker device for negotiating access to at least a portion of the spectrum;
receiving an agreement message including an advertisement text from the broker device when the first user device agrees to negotiating terms associated with the broker device, wherein the advertisement text includes information related to the portion of the spectrum and the broker device; and
transmitting a packet including the advertisement text to at least one other user device such that the at least one other user device communicates with the broker device for allocation of the portion of the spectrum.

2. The method of claim 1, wherein the broker device is associated with an authorized agent of an entity authorized to use the spectrum.

3. The method of claim 1, wherein the broker device is authorized to use at least a portion of the spectrum.

4. The method of claim 1, wherein obtaining the address of the broker device comprises receiving the address of the broker device from a second user device.

5. The method of claim 1, wherein obtaining the address of the broker device comprises obtaining the address of the broker device from an internal memory of the first user device.

6. The method of claim 1, wherein sending the inquiry message further comprises:
sending the inquiry message to confirm availability of the portion of the spectrum;
receiving a confirmation message indicating the availability of the portion of the spectrum, wherein the confirmation message includes information for negotiating with the broker device; and
negotiating with the broker device for advertising the availability of the portion of the spectrum to the at least one user device.

7. The method of claim 1, wherein the negotiating terms includes at least one of a) updating advertisement text at regular intervals, b) length of the advertisement, c) frequency of transmission of the advertisement, d) cost of spectrum access, e) bandwidth of the portion of spectrum, f) length of time the portion of the spectrum is to be used, and g) a physical location.

8. The method of claim 1, wherein receiving an agreement message comprises receiving an agreement including an advertisement format referring to a predetermined advertisement text stored in the first user device.

9. The method of claim 1, wherein transmitting the packet including the advertisement text comprises:
obtaining the advertisement text from the received agreement message;
inserting the advertisement text in a predefined field of the packet; and
transmitting the packet to the at least one other user device.

10. The method of claim 9, where inserting the advertisement text comprises inserting the advertisement text in an unencrypted field of the packet such that the at least one other user device receives the advertisement.

11. The method of claim 1, wherein inserting the advertisement text comprises inserting the advertisement text in a first field of the packet such that the at least one other user device switches from an active mode to a sleep mode after detecting the advertisement text in the first field of the packet.

12. The method of claim 1, wherein transmitting the packet comprises transmitting the packet including the advertisement text at a predefined position in each sequence of packets transmitted by the first user device.

13. The method of claim 1, wherein the advertisement text indicates availability of in-band and out-of-band spectrum.

14. The method of claim 1, wherein the advertisement text is received individually as an advertisement message after receiving the agreement message from the broker device.

15. An apparatus for advertising spectrum in a communication system, the apparatus comprising:
a memory for storing an address associated with a broker device authorized to negotiate access to the spectrum; and
a processor coupled to the memory for obtaining the address and negotiating with the broker device for advertising availability of at least the portion of the spectrum to at least one user device.

16. The apparatus of claim 15 further comprises a transceiver coupled to the processor for transmitting a packet including an advertisement text indicating the availability of the at least the portion of the spectrum to the at least one user device.

17. The apparatus of claim 16, wherein the processor inserts the advertisement text in a predefined field of the packet.

18. The apparatus of claim 16, wherein the processor inserts the advertisement text in at least one of an unencrypted field of the packet, and a first field in the packet.

19. The apparatus of claim 15 further comprises a transceiver for receiving the address associated with the broker device from the at least one user device in the communication system.

20. The apparatus of claim 15, wherein the advertisement text includes information related to at least one of a) availability of the portion of the spectrum, b) terms of service, c) cost of service, d) special promotion, and e) contact information of a broker associated with the broker device.

21. The apparatus of claim 20, wherein the information is compressed in a form of indices to a predetermined look-up table so as to reduce transmission time in the communication system.

22. The apparatus of claim 15, wherein the processor negotiates on negotiating terms associated with the broker device when a user associated with the apparatus disagrees with at least one of the negotiating terms offered by the broker device.

23. A method by a broker device for advertising a spectrum, the method comprising:
receiving an inquiry message to confirm availability of at least a portion of the spectrum from a first user device;
sending a confirmation message indicating the availability of the portion of the spectrum, wherein the confirmation message includes information for negotiating with the first user device; and
negotiating with the first user device for advertising the availability of the at least the portion of the spectrum to at least one other user device; and
sending an agreement message including an advertisement text to the first user device when the first user device agrees to negotiating terms associated with the first user device.

24. The method of claim 23 further comprising transmitting an updated advertisement text at regular intervals to the first user device such that the first user device advertises the updated advertisement text to the at least one other user device.

25. The method of claim 23, wherein negotiating with the first user device comprises providing a discount on the portion of the spectrum accessed by the first user device when the first user device agrees to transmit the advertisement text to the at least one other user device.

26. The method of claim 23, wherein sending the agreement message comprises sending the agreement message including the advertisement text to the first user device such that the first user device transmits the advertisement text to the at least one other user device.
